(19) United States
(12) Patent Application Publication
(10) Pub. No.: US 2006/0266089 A1
(43) Pub. Date: Nov. 30, 2006

(54) Hybrid key

(76) Inventor: Steven J. Dimig, Plymouth, WI (US)

Correspondence Address: MICHAEL BEST & FRIEDRICH, LLP, 100 E WISCONSIN AVENUE, MILWAUKEE, WI, 53202, US

(21) Appl. No.: 11/139,029

(22) Filed: May 26, 2005

(51) Int. Cl. E05B 19/04; B60R 25/02

(52) U.S. Cl. 70/252; 70/408

(57) ABSTRACT

A hybrid key for use with a mechanical vehicle entry system and a radio frequency identification (RFID) ignition system. The key can include a mechanical blade that can be received by a vehicle lock, a nose section integrally coupled to the mechanical blade, and a radio frequency transponder housed within the nose section. The nose section and the mechanical blade can be received by an ignition module of the RFID ignition system. The key can include a key head section integrally coupled to the nose section and shaped for an operator to grasp.

### BACKGROUND

Security systems for vehicles often include a security device for the vehicle entry system and a security device for the ignition system. Conventionally, a mechanical system using a single mechanical key allows an operator to gain access into the vehicle and start the engine of the vehicle.

Some vehicles use a radio frequency identification (RFID) system in combination with the mechanical key to secure the ignition while others use the RFID system by itself. Some vehicles use a remote keyless entry (RKE) system or a passive entry system in addition to the mechanical key to secure the vehicle doors. However, RFID systems, RKE systems, and passive entry systems are not always offered as options for all vehicle makes and models.

If the ignition system uses an RFID exclusive system, but the vehicle entry system uses mechanical locks, an operator must carry two separate security devices to enter and operate the vehicle. More specifically, a remote keyless entry system or a passive entry system may not be offered as options on some vehicles, but those vehicles may be equipped with an RFID ignition system. Alternatively, an RFID ignition system may not be offered as an option on some vehicles, but those vehicles may be equipped with a remote keyless entry system or a passive entry and start system.

### SUMMARY OF THE INVENTION

In light of the above, a need exists for a device that combines two separate security devices necessary for the vehicle entry system and the ignition system when an RFID system is used in only one of the two systems. For example, a need exists for a device that combines the two separate security devices necessary for an RFID exclusive ignition system and a mechanical vehicle entry system (e.g., when remote keyless entry and/or passive entry are not options for the vehicle).

In one embodiment, the invention provides a key for use with a mechanical vehicle entry system and an RFID exclusive ignition system. The key can include a mechanical blade capable of being received by a door lock of the mechanical vehicle entry system. The key can include a nose section integrally coupled to the mechanical blade. A radio frequency (RF) transponder can be housed within the nose section. The nose section and the mechanical blade can be capable of being received by an ignition module of the RFID exclusive ignition system. The key can also include a key head section integrally coupled to the nose section. The key head section can be shaped for an operator to grasp.

In another embodiment, the invention provides a vehicle including a mechanical entry system and an RFID exclusive ignition system. The vehicle can include a mechanical door lock for receiving a mechanical blade of a key. The vehicle can include an ignition module for receiving the mechanical blade of the key and a nose section of the key. The nose section can house a RF transponder. The nose section can be integrally coupled to the mechanical blade. The vehicle can also include an antenna connected to the ignition module to receive a signal from the RF transponder. The vehicle can further include an authentication module connected to the antenna and/or the ignition module. The authentication module can determine if the key is authorized to actuate the RFID exclusive ignition system.

In another embodiment, the invention provides a method of entering and starting a vehicle having a mechanical entry system and an RFID exclusive ignition system. The method can include inserting a mechanical blade of a key into a door lock of the mechanical entry system and allowing the door lock to unlock if the mechanical blade is properly coded. The method can also include inserting the mechanical blade and a nose section of the key into an ignition module of the RFID exclusive ignition system. The nose section can be integrally coupled to the mechanical blade of the key. The method can further include transmitting a signal from a RF transponder housed in the nose section of the key to an antenna connected to the ignition module and allowing the vehicle to start if the key is authorized.

Other aspects of the invention will become apparent by consideration of the detailed description and accompanying drawings.

### BRIEF DESCRIPTION OF THE DRAWINGS

FIG. 1 is a perspective view of a hybrid key.

FIG. 2 is a perspective view of an ignition module for receiving the hybrid key.

FIG. 3 is a schematic illustration of a vehicle including the hybrid key of FIG. 1 and the ignition module of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

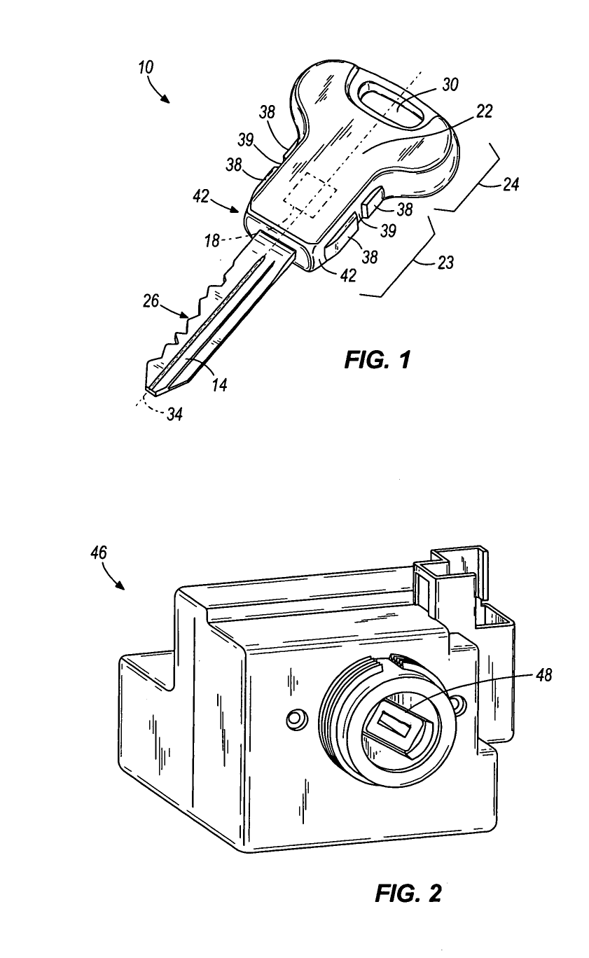

FIG. 1 illustrates a hybrid key 10 according to one embodiment of the invention. The hybrid key 10 can include a mechanical blade 14 and a radio frequency (RF) transponder 18 enclosed in a housing 22. The mechanical blade 14 can include one or more surfaces 26, for example, having an arrangement of teeth. The mechanical blade 14 can include one of many surfaces 26 in order to decrease the likelihood of an identical key intended for a different vehicle being used to fraudulently enter a vehicle.

In one embodiment of the invention, the mechanical blade 14 can be used to unlock the vehicle entry system, but cannot be used to actuate the ignition system. The, mechanical blade 14 of the hybrid key 10 can be used to unlock vehicle door locks and/or vehicle compartment locks (e.g., a trunk lid lock or a glove box lock) having any suitable types of mechanical latches. The mechanical blade 14 of the hybrid key 10 can be inserted into a vehicle door lock and/or a vehicle compartment lock. If the surface 26 of the mechanical blade 14 matches a coded surface of the lock, an operator can turn the mechanical blade 14 in order to move a mechanical latch from a locked state to an unlocked state.

As shown in FIG. 1, the housing 22 can be integrally coupled to the mechanical blade 14 of the hybrid key 10. In one embodiment, the housing 22 can include a nose section 23 containing the RF transponder 18 and a key head section 24 for an operator to grasp. The RF transponder 18 can be molded or assembled into any desired portion of the housing 22. In some embodiments, the key head section 24 or any other suitable portion of the housing 22 can include an aperture 30 to receive a key ring or other fastening mechanism. In some embodiments, the key head section 24 of the housing 22 can extend outward with respect to a longitudinal axis 34 of the mechanical blade 14 so that an operator can more easily grip the hybrid key 10. However, the shape and size of the nose section 23, the key head section 24, and/or the entire housing 22 can vary according to any suitable ergonomic or aesthetic design considerations.

As shown in FIG. 1, the housing 22 can include a protrusion 38 and/or a recess 39 along the edge surfaces 42 of the housing 22. The protrusion 38 and/or the recess 39 can mate with a portion of a key slot 48 of the ignition module 46 (as shown in FIG. 2) to hold the hybrid key 10 in a proper position with respect to the ignition module 46. The protrusion 38 and/or the recess 39 can interact with a biasing member (not shown) in the key slot 48 to prevent the hybrid key 10 from being removed from the key slot 48 when the engine is running or when the vehicle's transmission is not in park. For example, the key slot 48 can include an annular protrusion (not shown) that mates with the recess 39 when the hybrid key 10 is properly positioned in the key slot 48.

FIG. 2 illustrates the ignition module 46 with the key slot 48 that can receive the hybrid key 10. In one embodiment of the invention, when the hybrid key 10 is inserted into the key slot 48 of the ignition module 46, the mechanical blade 14 is fully received within the key slot 48, but the mechanical blade 14 does not actuate any component of the RFID ignition system. With the mechanical blade 14 fully received, the nose section 23 (and thus, the RF transponder 18) of the hybrid key 10 can be at least partially received and held in the proper position within the key slot 48 of the ignition module 46. In this position, the RF transponder 18 of the hybrid key 10 can communicate with and actuate the RFID ignition system.

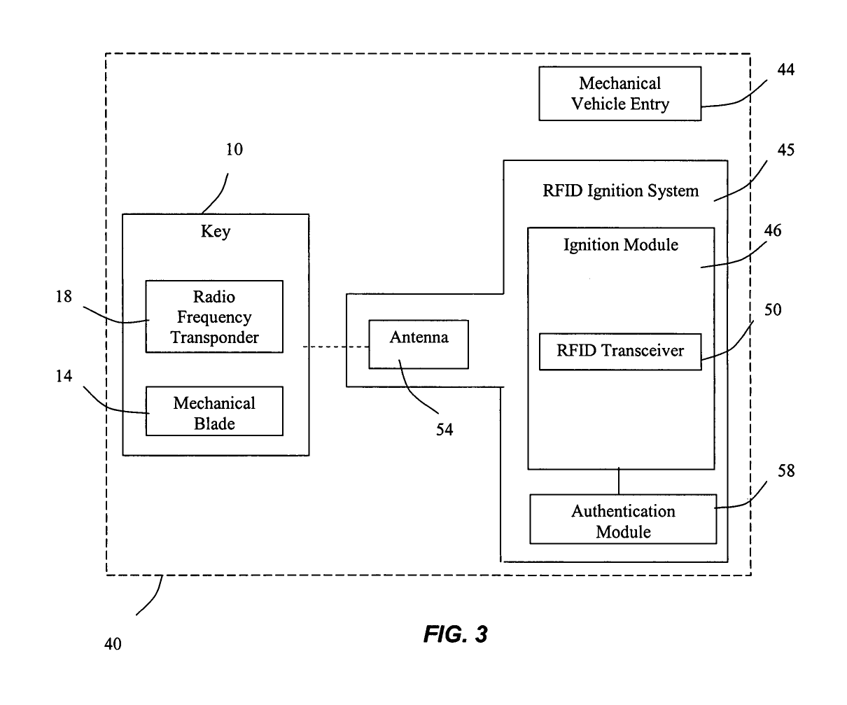

FIG. 3 is a schematic illustration of a vehicle 40 including the hybrid key 10, a mechanical vehicle entry system 44, and an RFID ignition system 45. The RFID ignition system 45 can include the ignition module 46, an RFID transceiver 50, an antenna 54, and an authentication module 58. The RFID transceiver 50 can be located within the ignition module 46 or can be connected to the ignition module 46. The RFID transceiver 50 can be connected to the antenna 54 and the authorization module 58. The antenna 54 can be located in the ignition module 46 or in any other suitable location within the vehicle, such as in the steering column. The authorization module 58 can be integral with or connected to any suitable vehicular control module. The authentication module 58 can determine whether the hybrid key 10 is authorized to actuate the RFID ignition system 45.

When the hybrid key 10 is inserted into the key slot 48, the RFID transceiver 50 can be activated. Once activated, the RFID transceiver 50 can generate a random number, which can be transmitted to the RF transponder 18 of the hybrid key 10. The RF transponder 18 can combine the random number with its own unique serial number to encrypt the new number. The new encrypted number can be transmitted back to the antenna 54 and the RFID transceiver 50. If the encrypted number does not match the authorized number stored in the authentication module 58, the hybrid key 10 cannot be used to actuate the RFID ignition system 45 and the engine of the vehicle 40 will not start. If the encrypted number matches the authorized number stored in the authentication module 58, the hybrid key 10 can be used to actuate the RFID ignition system 45 and start the engine of the vehicle 40 (e.g., by rotating or otherwise moving the hybrid key 10 with respect to the ignition module 46).

In an alternative embodiment of the invention, the hybrid key 10 can be used with a passive entry system and a mechanical ignition system. To enter the vehicle, a transponder of the hybrid key 10 can communicate with a transceiver connected to the vehicle door locks. To start the vehicle, the mechanical blade 14 can be inserted into a key slot of a mechanical ignition module to operate, for example, a lock cylinder. In some embodiments, the mechanical blade 14 can also be used as a back-up to the passive entry system in order to unlock the vehicle door locks and/or the vehicle compartment locks.

Various features and advantages of the invention are set forth in the following claims.

What is claimed is:

1. A key for use with a mechanical vehicle entry system and a radio frequency identification ignition system, the key comprising:
a mechanical blade capable of being received by a door lock of the mechanical vehicle entry system;
a nose section integrally coupled to the mechanical blade;
a radio frequency transponder housed within the nose section, the nose section and the mechanical blade capable of being received by an ignition module of the radio frequency identification ignition system; and
a key head section integrally coupled to the nose section, the key head section shaped for an operator to grasp.

2. The key of claim 1 wherein the nose section includes at least one of a protrusion and a recess capable of being received by the ignition module in order to hold the radio frequency transponder in position with respect to the radio frequency identification ignition system.

3. The key of claim 1 wherein the mechanical blade is capable of being received by the ignition module but cannot actuate the ignition module.

4. The key of claim 1 wherein at least one of the nose section and the key head section includes an aperture for receiving a key ring.

5. The key of claim 1 wherein the radio frequency transponder communicates with an antenna and an authentication module connected to the ignition module to determine if the key is authorized for actuating the radio frequency identification ignition system.

6. A vehicle including a mechanical entry system and a radio frequency identification ignition system, the vehicle comprising:
a mechanical door lock for receiving a mechanical blade of a key;
an ignition module for receiving the mechanical blade of the key and a nose section of the key, the nose section housing a radio frequency transponder, the nose section being integrally coupled to the mechanical blade;
an antenna connected to the ignition module, the antenna receiving a signal from the radio frequency transponder; and
an authentication module connected to at least one of the antenna and the ignition module, the authentication module determining if the key is authorized to actuate the radio frequency identification ignition system.

7. The vehicle of claim 6 wherein the ignition module receives at least one of a protrusion and a recess of the nose section in order to hold the radio frequency transponder in position with respect to the antenna.

8. The vehicle of claim 6 wherein the ignition module includes a radio frequency identification transceiver connected to the antenna and the authentication module.

9. A method of entering and starting a vehicle having a mechanical entry system and a radio frequency identification ignition system, the method comprising:
inserting a mechanical blade of a key into a door lock of the mechanical entry system;
allowing the door lock to unlock if the mechanical blade is properly coded;
inserting the mechanical blade and a nose section of the key into an ignition module of the radio frequency identification ignition system, the nose section being integrally coupled to the mechanical blade;
transmitting a signal from a radio frequency transponder housed in the nose section of the key to an antenna connected to the ignition module; and
allowing the vehicle to start if the key is authorized.

10. The method of claim 9 and further comprising securing the key with respect to the ignition module with at least one of a protrusion and a recess located on the nose section of the key.

11. The method of claim 9 and further comprising providing a key head section for an operator to grasp, the key head section integrally coupled to the nose section of the key.
